(19) United States
(12) Patent Application Publication
(10) Pub. No.: US 2008/0159209 A1
(43) Pub. Date: Jul. 3, 2008

(54) METHOD AND SYSTEM FOR ALLOCATING CHANNELS IN A WIRELESS NETWORK

(75) Inventor: BYUNG SEO KIM, HOFFMAN ESTATES, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/619,368

(22) Filed: Jan. 3, 2007

(51) Int. Cl. H04Q 7/00

(52) U.S. Cl. 370/329

(57) ABSTRACT

A method and system for allocating channels in a wireless network is provided. The wireless network includes a plurality of electronic devices organized into clusters. The plurality of electronic devices communicates with each other through a plurality of channels. The method performed by an electronic device includes scanning the plurality of channels for a frame generated in a first cluster and determining that the frame is a beacon frame transmitted by a first cluster header in the first cluster. Further, the method includes sending a channel request to the first cluster header and receiving a channel request response from the first cluster header. Moreover, the method includes designating the electronic device as a second cluster header for a second cluster.

The present invention generally relates to wireless networks, and more particularly, to a method and system for allocating channels in a wireless network.

### BACKGROUND OF THE INVENTION

Wireless networks provide wireless applications to wireless communication devices. Some wireless applications such as multimedia and video conferencing require high bandwidth and an enhanced quality of service. A single channel for the wireless network may not be adequate to cope with the bandwidth and the quality of service requirements of such applications. As a result, multiple channels are used in wireless networks to improve performance. In addition, the wireless communication devices of the wireless network may be organized into one or more groups (also termed “clusters”) to further enhance performance.

Allocating channels in wireless networks is done in a number of ways. One such way is to allow each wireless communication device to dynamically negotiate channels so that multiple communications can take place. This is supported by a protocol termed multi-channel Media Access Control (MAC). However, multi-channel MAC does not allow for inter cluster channel allocation which enables performance improvements of the wireless network. Another way of allocating channels is to simply allocate a different channel to each cluster in the wireless network. However, allocating a different channel to each cluster limits each cluster to only one channel. As a result, throughput of the cluster may degrade as communications increase in the wireless network. Further, simply allocating a different channel to each cluster also does not allow for inter cluster channel allocation.

Accordingly a new method and system for allocating channels in a wireless network is needed.

### BRIEF DESCRIPTION OF THE FIGURES

The accompanying figures, where like reference numerals refer to identical or functionally similar elements throughout the separate views, and which, together with the detailed description below, are incorporated in and form a part of the specification, serve to further illustrate various embodiments and explain various principles and advantages, all in accordance with the present invention.

FIG. 1 illustrates a wireless network where various embodiments of the present invention can be practiced;

FIG. 2 illustrates a flow diagram for allocating channels in a wireless network;

FIG. 3 illustrates a block diagram of an electronic device;

FIGS. 4 and 5 illustrate flow diagrams for allocating channels in a wireless network;

FIG. 6 illustrates a message flow diagram for making a request for channels by a cluster header;

FIG. 7 illustrates a message flow diagram for negotiating channels between cluster headers;

FIG. 8 illustrates a message flow diagram for selecting an intermediate electronic device;

FIG. 9 illustrates a message flow diagram for indicating a change of a channel for an intermediate electronic device and a cluster header;

FIG. 10 illustrates an example More Channel Request (MCR) message; and

FIG. 11 illustrates an example More Channel Assign (MCA) message.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

Before describing the particular method and system for allocating channels in a wireless network, in accordance with various embodiments of the present invention, it should be observed that the present invention resides primarily in combinations of method steps and system components relating to the allocation of channels in a wireless network. Accordingly, the method steps and system components have been represented, where appropriate, by conventional symbols in the drawings, showing only those specific details that are pertinent for an understanding of the present invention, so as not to obscure the disclosure with details that will be readily apparent to those with ordinary skill in the art having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

In accordance with an embodiment, a method for allocating channels in a wireless network is provided. The wireless network includes a plurality of electronic devices organized into at least one cluster. The plurality of electronic devices is capable of communicating with each other through a plurality of channels. The method performed by an electronic device in the wireless network includes scanning the plurality of channels for a frame generated in a first cluster. The method also includes determining that the frame is a beacon frame transmitted by a first cluster header in the first cluster. Further, the method includes sending a channel request to the first cluster header and receiving a channel request response from the first cluster header. Moreover, the method includes designating the electronic device as a second cluster header for a second cluster.

In accordance with an embodiment, an electronic device is provided. The electronic device includes a receiver that is capable of receiving a beacon frame from a first cluster header in a wireless network. The wireless network is organized into one or more clusters. The electronic device also includes a transmitter that is capable of transmitting a channel request in response to receiving the beacon frame. Moreover, the electronic device includes a processor that is capable of creating a second cluster in response to the channel request. The electronic device is designated as a second cluster header.

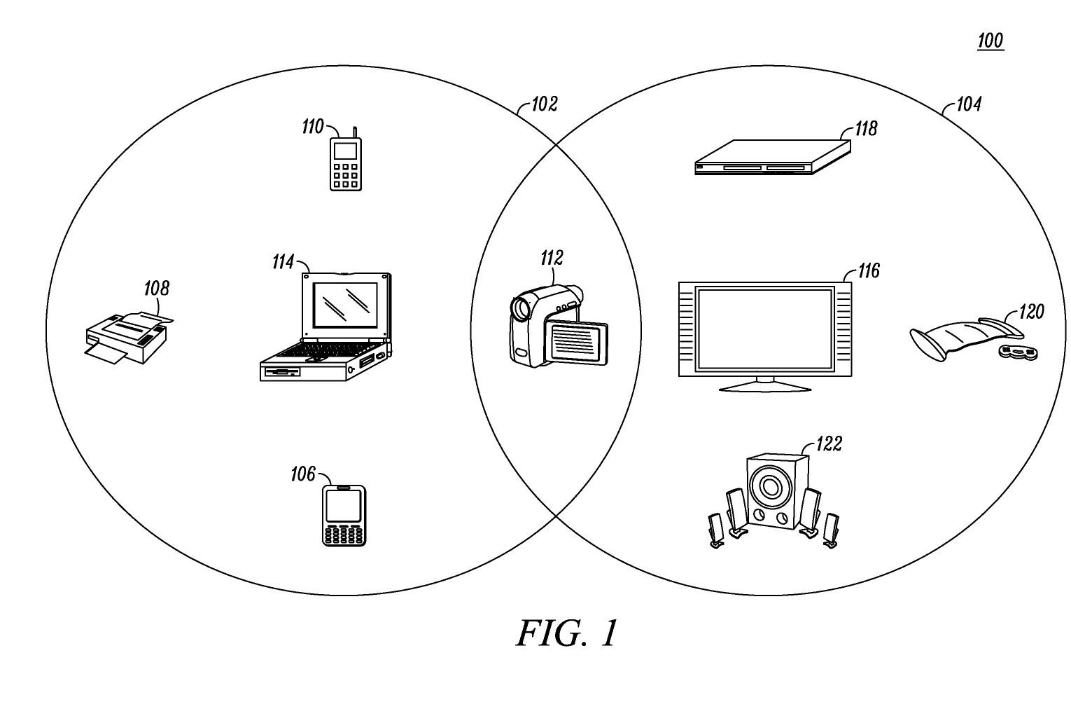

FIG. 1 illustrates a wireless network 100 where various embodiments of the present invention can be practiced. Some examples of the wireless network 100 are ones adhering to Institute of Electrical and Electronics Engineers (IEEE) 802.11, IEEE 802.15, WiFi, Zigbee, and RFID. In any case, the wireless network 100 includes a plurality of clusters. For the purpose of this description, the wireless network 100 is shown to include a first cluster 102 and a second cluster 104. A cluster is a self-configurable group of electronic devices that can communicate wirelessly. As shown in FIG. 1, the first cluster 102 is organized as a home applications cluster and includes electronic devices such as a Personal Digital Assistant (PDA) 106, a printer 108, a mobile phone 110, a camcorder 112, and a laptop computer 114. For the purpose of this description, the laptop computer 114 is configured as a cluster header, and will hereinafter be referred to as a first cluster header. A cluster header is an electronic device that is responsible for determining parameters (e.g. time of offset, number of channels, and communication data rates) required for operating a cluster and broadcasting the parameters so that the electronic devices are aware of these parameters. Further, the cluster header is responsible for sending a channel request to a neighboring cluster. In any case, the Personal Digital Assistant (PDA) 106, the printer 108, the mobile phone 110, the camcorder 112, and the laptop computer 114 in the first cluster 102 communicate with one another through one or more channels in the wireless network 100.

As shown in FIG. 1, the second cluster 104 is organized as, for example, an entertainment application cluster and includes electronic devices such as the camcorder 112, a television 116, a DVD player 118, a play station 120, and a sound system 122. For the purpose of this description, the television 116 is configured as a cluster header, and will hereinafter be referred to as a second cluster header. The camcorder 112 is located in the overlapping region of the first cluster 102 and the second cluster 104. As a result, the camcorder 112 is considered to be an intermediate electronic device between the first cluster 102 and the second cluster 104.

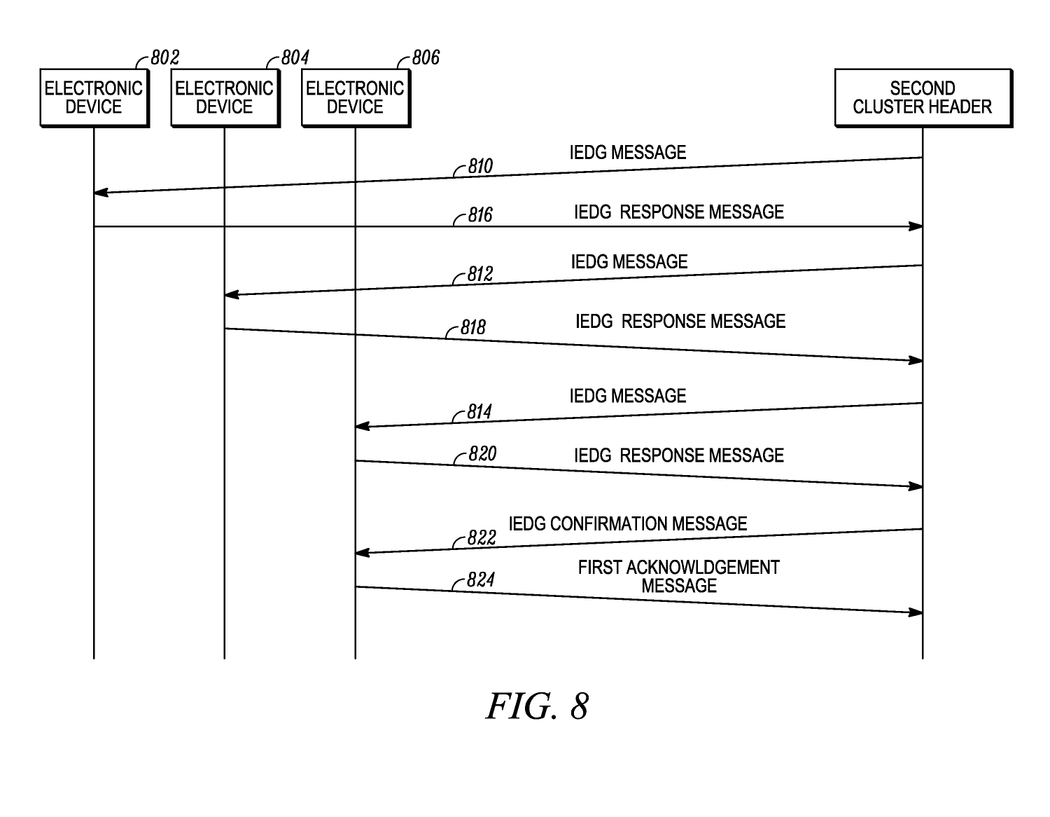

In one embodiment, the electronic devices in the first cluster 102 and the electronic devices in the second cluster 104 communicate through the intermediate electronic device, e.g. the camcorder 112. In any case, the intermediate electronic device is located in the overlapping region of the two clusters. The intermediate electronic device enables communication between the electronic devices of the different clusters that are not within direct communication range of each other. Selection of an intermediate device will be described in conjunction with FIG. 8.

As mentioned above, a cluster header is responsible for sending a channel request to a neighboring cluster. The channel request is a message used by the cluster header to request channels from another cluster header. For example, the second cluster header 116 in the wireless network 100 may request the first cluster header 114 to allocate one or more channels. The second cluster header 116 may make such a request to achieve higher network performance (e.g. higher throughput) in the second cluster 104. Further, an electronic device in the wireless network 100 can also request a channel or a number of channels by sending a channel request to a neighboring cluster when the electronic device wishes to create its own cluster. Thus, allocation of channels in the wireless network 100 occurs by accommodating channel requests by cluster headers and by electronic devices wishing to become cluster headers.

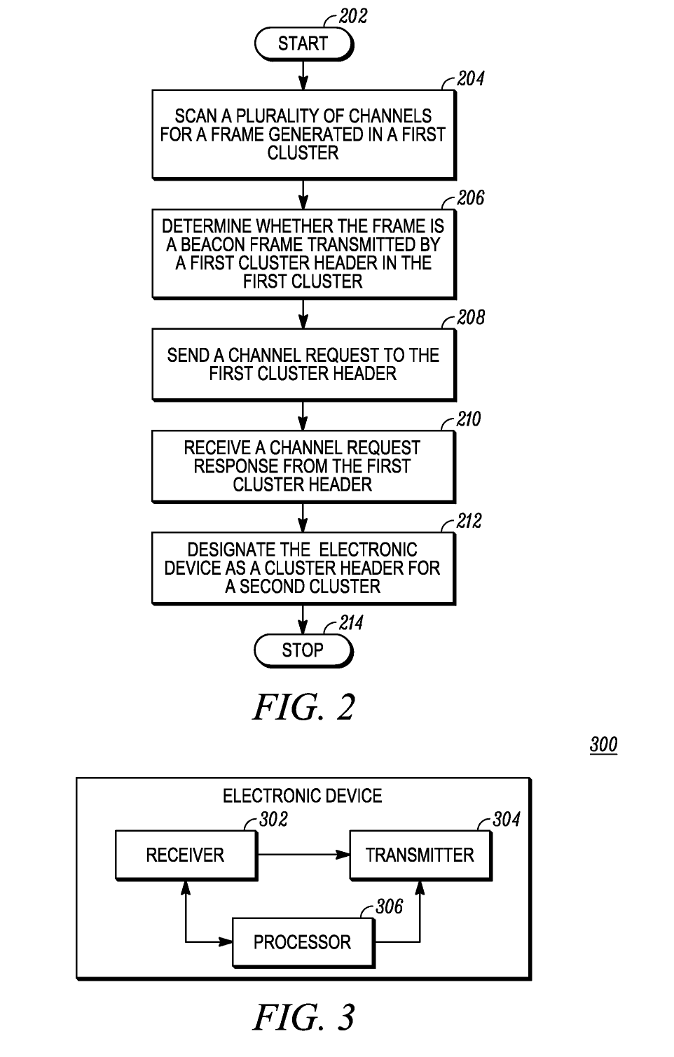

FIG. 2 illustrates a flow diagram for allocating channels in a wireless network 100. As such, in one embodiment, an electronic device in the wireless network performs the steps shown in FIG. 2. The electronic device scans a plurality of channels for a frame generated in a first cluster (step 202). For example, the television 116 in the wireless network 100 scans a plurality of channels for a frame generated in the first cluster 102 to determine whether a cluster exists around the television 116.

As is known to one of ordinary skill in the art, frames are transmitted by electronic devices when communicating with each other. Example types of frames include a beacon frame, a control frame, and a data frame. The beacon frame is transmitted periodically by an electronic device that is designated as a cluster header of a cluster. The control frame has information needed to safely deliver data to the electronic devices in the wireless network. The data frames have the data to be delivered to the electronic devices in the wireless network. In one embodiment, the beacon frame includes information such as a timestamp, a Service Set Identifier (SSID), the number of channels being used in the wireless network, and a channel ID list that identifies the channels allocated for the cluster. Further, the information found in the beacon frame may also have the number of electronic devices in the cluster and/or the number of channels used in the cluster.

In any case, the electronic device determines whether the frame is a beacon frame transmitted by a first cluster header in the first cluster (step 206). In one embodiment, prior to determining whether the frame is a beacon frame, the electronic device determines whether any frames (beacon or not) are transmitted. If frames are transmitted and it is determined that there is no beacon frame, the electronic device creates a cluster header through choosing an intermediate electronic device. If frames are transmitted and it is determined that there is a beacon frame, then the electronic device determines whether it needs to create a cluster header. In the alternative, if the electronic device determines that there are no frames (beacon or not) being transmitted, then the electronic device creates a cluster header.

A channel request is sent by the electronic device (e.g. television 116) to the first cluster header (e.g. 114) directly or through choosing an intermediate electronic device, so that the electronic device can access the channels in the first cluster (e.g. 102) (step 208). In one embodiment, the channel request may be sent when an electronic device (e.g. the television 116) is trying to create its own cluster. In another embodiment, the channel request may be sent when a higher network throughput in its own cluster is desired. In any case, a channel request response is received from the first cluster header (step 210) and the electronic device (e.g. the television 116) is designated as a cluster header of the second cluster 104 (step 212).

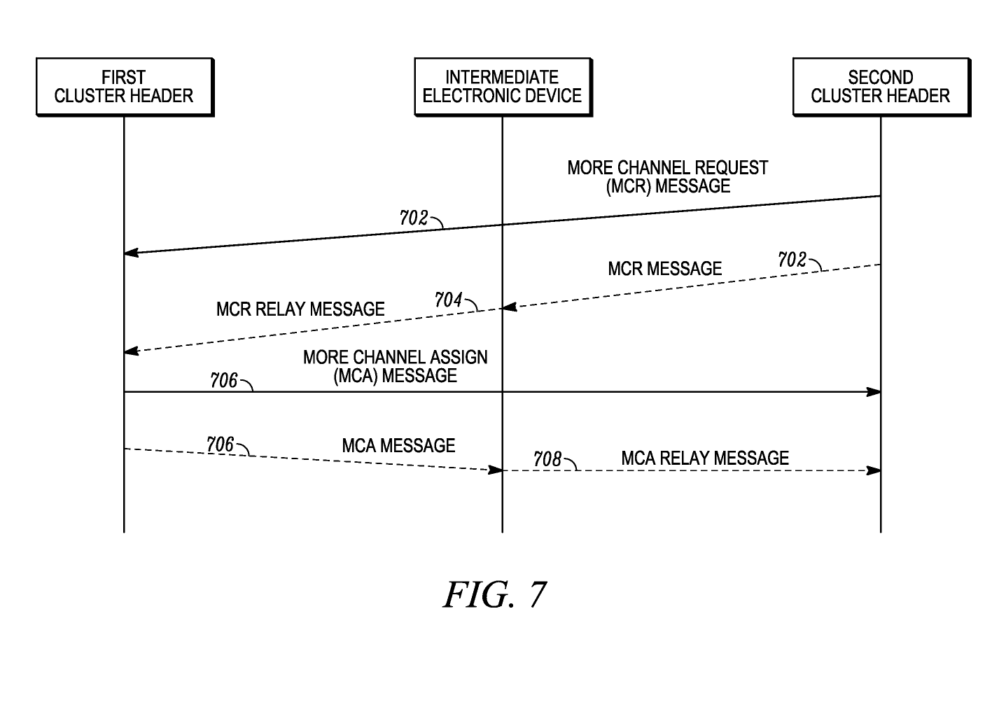

In an embodiment, the channel request is a specific type of message termed a More Channel Request (MCR) message. In such an embodiment, the second cluster header (e.g. television 116) sends the MCR message to the first cluster header when the second cluster header needs one or more channels. In such an embodiment, the first cluster header may compare a traffic load of the first cluster with that of the second cluster to determine whether a channel is necessary. Otherwise, the first cluster header selects a channel for the second cluster to be able to respond to the second cluster header's request for a channel. In response, the first cluster header sends a More Channel Assign (MCA) message which specifies the allocated channel for the second cluster to the second cluster header. As such, the MCA message is a specific type of channel request response. In any case, selecting a channel for the second cluster occurs by the second cluster header negotiating for channels with the first cluster header and is further described with reference to FIG. 7.

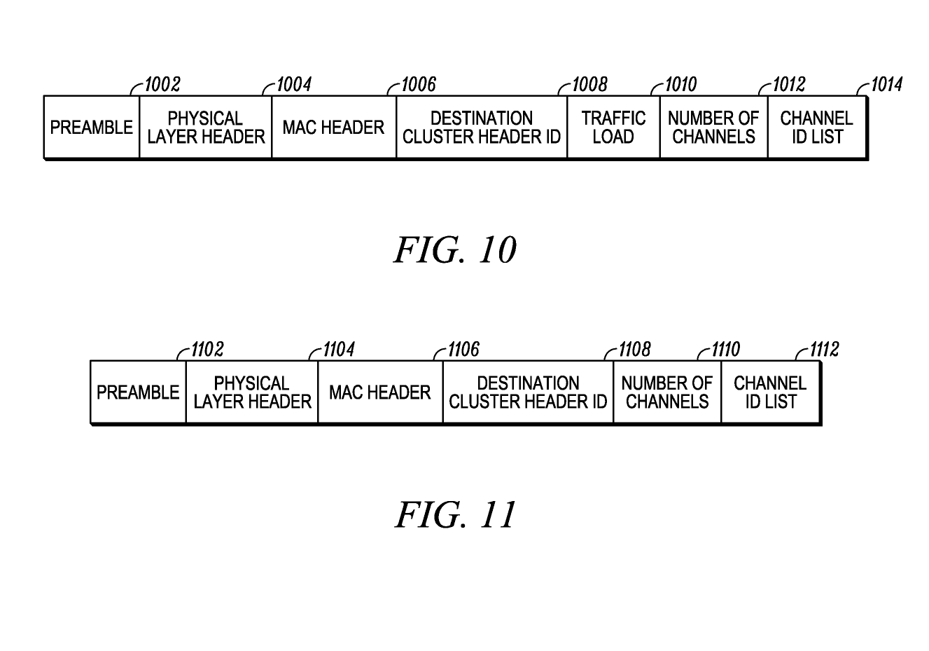

In any case, MCR and MCA messages may be proprietary messages that signal information. As such, MCR and MCA messages have unique message IDs that identify the type of the proprietary message and may be identified in a MAC header of the proprietary message. Further, the MCR message may include information about a traffic load and/or number of channels used in the cluster requesting one or more channels. An example MCR message is illustrated in FIG. 10. In such an example, the MCR message has a preamble 1002, a physical layer header 1004, a Medium Access Control (MAC) header 1006, a destination cluster header ID 1008, a traffic load field 1010, a number of channels field 1012, and a channel ID list 1014. In such an example, the destination cluster header ID 1008 identifies a destination cluster (e.g. the first cluster header), the traffic load field 1010 provides a traffic load and/or status of the cluster that sent the MCR message, the number of channels field 1012 indicates the number of channels being used in the cluster that sent the MCR message, and the channel ID list 1014 provides channel IDs being used in the cluster that sent the MCR message.

In an embodiment, the MCA message may include an identifier to the one or more channels that are allocated to the cluster requesting one or more channels. An example MCA message is illustrated in FIG. 11. In such an example, the MCA message has a preamble 1102, a physical layer header 1104, a Medium Access Control (MAC) header 1106, a destination cluster header ID 1108, a number of channels field 1010, and a channel ID list 1012. In such an example, the destination cluster header ID 1108 identifies a destination cluster (e.g. the second cluster header), the number of channels field 1110 indicates the number of channels being assigned to the cluster that sent the MCR message, and the channel ID list 1112 provides channel IDs being assigned to the cluster that sent the MCR message.

In one embodiment, when all channels in the first cluster (e.g. 114) are used, an electronic device sends a channel request (e.g. an MCR message) to an intermediate electronic device (e.g. 112) to request more channels. The channel request is then forwarded by the intermediate electronic device to the first cluster header. In such a case, a channel may be selected by the first cluster header for the second cluster (e.g. 104) based on predefined criteria. Examples of predefined criteria include signal strength, channel conditions, and quality of service. As an example, the first cluster header may select a channel that provides better quality of service for the second cluster. In any case, the second cluster header (e.g. 116) is notified of the selected channel available for the second cluster (e.g. via a MCA message) in response to the channel request and then the selected channel may be used by the electronic devices in the second cluster.

In one embodiment, a third cluster header may be created by following a similar process. Namely, an electronic device (e.g. a second electronic device) scans a plurality of channels for a frame generated in the first cluster. If a frame is not detected and the electronic device determines to create its own cluster, then at least one channel is selected from the plurality of channels to create a third cluster from the selected channel. In such a manner, the electronic device (e.g. the second electronic device) is designated as the third-cluster header.

FIG. 3 illustrates a block diagram of an electronic device 300. The electronic device 300 includes a receiver 302, a transmitter 304, and a processor 306. The receiver 302 is capable of receiving a beacon frame from a cluster header in a wireless network (e.g. 100) that is organized into one or more clusters. For example, the electronic device 300 can receive a beacon frame from the first cluster header (e.g. 114). If the electronic device 300 wants its own cluster header, the transmitter 304 is capable of transmitting a channel request to the first cluster header after scanning for available channels. A channel request is sent to obtain access to a channel (or channels) from the cluster. The processor 306 is capable of creating a second cluster (e.g. 104) in response to the channel request message. The electronic device 300 is designated as a second cluster header. As is known to one of ordinary skill in the art, the receiver 302 and the transmitter 304 may be integrated in one embodiment. Thus, the depiction of the receiver shown separate from the transmitter in FIG. 3 is only illustrative.

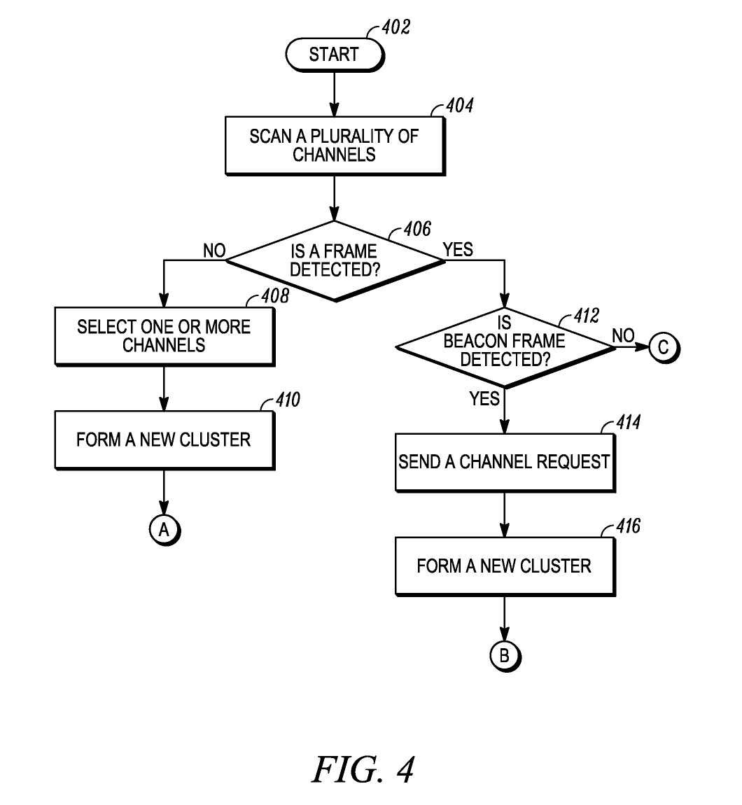

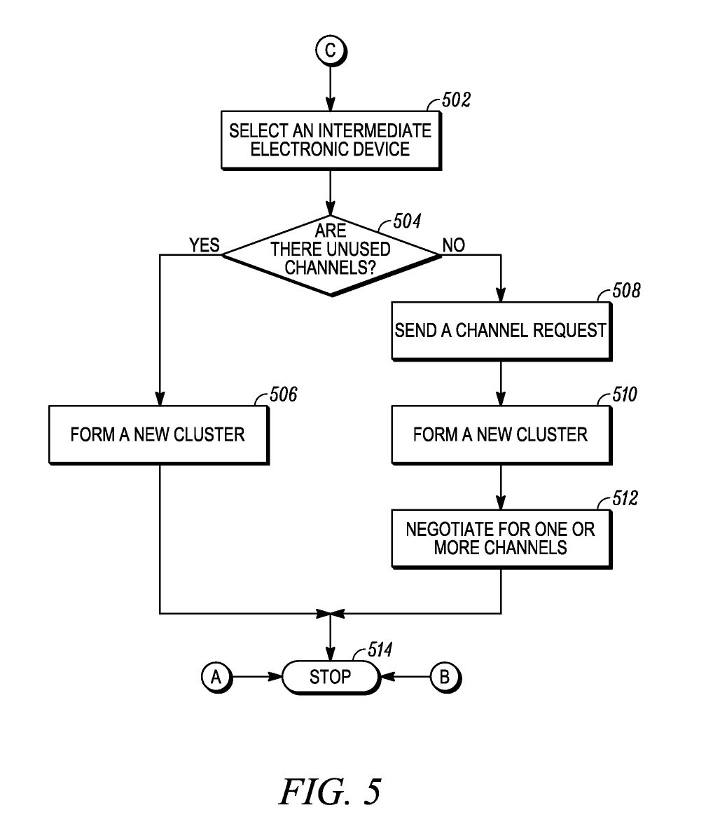

FIGS. 4 and 5 illustrate flow diagrams for allocating channels in a wireless network. After initiating (step 402), a plurality of channels is scanned, e.g. by an electronic device such as the television 116 (step 404). The plurality of channels is scanned to detect frames generated in, e.g. the first cluster 102. Whether a frame has been detected (step 406) is determined during the step of scanning. If it is determined that the frame has been undetected (step 406), then one or more channels are selected from the channels that are available for use (step 408) and a new cluster, e.g. the second cluster 104, is formed by using the selected one or more channels (step 410). By following this process, the new cluster (e.g. the second cluster 104) having a cluster header is formed whereby the electronic device performing the steps of 404-410 is designated the cluster header.

If it is determined that a frame has been detected (step 406), then whether the detected frame is a beacon frame is determined (step 412). If it is determined that the frame is a beacon frame, then a channel request is sent to form (step 414) a new cluster. Thus, a new cluster is created (step 416) and the electronic device is designated as a cluster header.

If it is determined that a beacon frame is undetected (steps 406, 412), or alternatively, that a non-beacon frame has been detected (steps 406,412), an intermediate electronic device is selected (step 502), e.g. by following the process illustrated in FIG. 8. In one example, the electronic device performing the steps 404, 406, 412, is selected as the intermediate electronic device. Then, whether there are unused channels, e.g. in the first cluster 102, is determined (step 504). If it is determined that unused channels exist, a new cluster, e.g. the second cluster 104, is created (step 506). In any case, the electronic device, e.g. television 116, performing the steps 404, 406, 504, 506 is designated as the cluster header. If it is determined that no unused channels exist in the first cluster 102 (step 504), a channel request is sent (step 508). Then, a new cluster, e.g. the second cluster 104, is formed (step 510) and the electronic device is designated as the cluster header of the new cluster. The new cluster header, e.g. the second cluster header 116, negotiates for channels with the first cluster header (e.g. 114) (step 512).

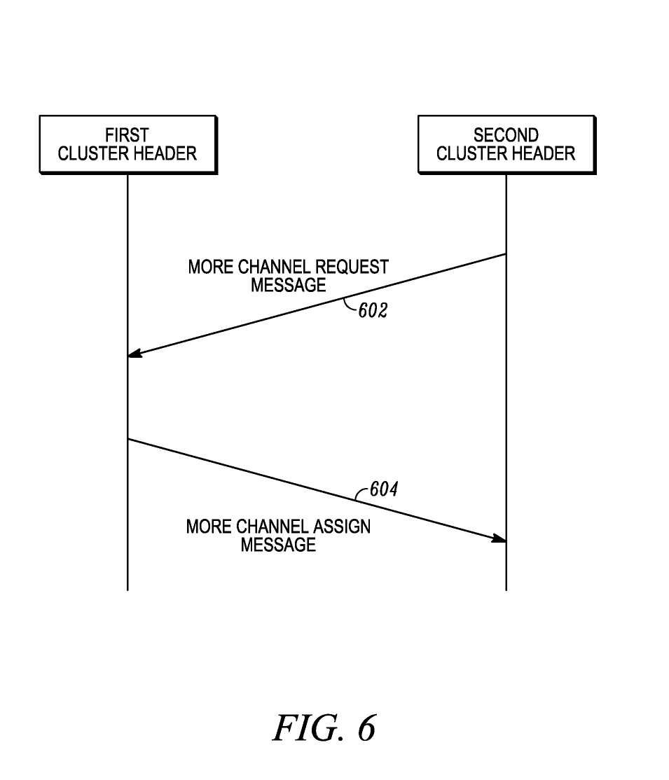

FIG. 6 illustrates a message flow diagram for making a request for one or more channels by a cluster header. In one example, a second cluster header (e.g. 116) request one or more channels from a first cluster header (e.g. 114). In one embodiment, as mentioned previously, a MCR message 602 is sent by the second cluster header to gain access to one or more channels of the first cluster header. If there are unused channels in the first cluster (e.g. 102), a MCA message 604 indicating one or more channels allocated to the first cluster is sent by the first cluster header to the second cluster header. Thus, unused channel or channels in the first cluster header can be inferred.

In an embodiment, the first cluster header compares a traffic load of the first cluster with that of the second cluster. Further, in such an embodiment, the channel may be allocated to the second cluster based upon comparison of the traffic load of the first cluster with that of the second cluster. In such an embodiment, to allocate a channel to the second cluster, negotiating for channels takes place. In any case, negotiating for channels between the first cluster header and the second cluster header is described in conjunction with FIG. 7.

FIG. 7 illustrates a message flow diagram for negotiating channels between cluster headers, e.g. a second cluster header 116 and a first cluster header 114. In an embodiment, negotiating takes place between the first cluster header and the second cluster header when there are no unused channels in a first cluster. In an embodiment, the first cluster header and the second cluster header communicate through an intermediate electronic device (e.g. 112). To initiate the process for negotiating for channels, the second cluster header sends a MCR message 702 to the first cluster header. The MCR message 702 is sent by the second cluster header to request allocation of one or more channels that are allocated to the first cluster. Because the MCR message 702 includes information about a traffic load (e.g. 1010 of FIG. 10) and the number of channels being used (e.g. 1012 of FIG. 10) in the second cluster, the information may be used by the first cluster header when determining whether to allocate one or more channels to the second cluster header.

In an embodiment, the MCR message 702 is sent by the second cluster header to the first cluster header via the intermediate electronic device. The MCR message 702 is sent to the intermediate electronic device when a beacon frame is not detected by the second cluster header. In this embodiment, a MCR relay message 704 is sent by the intermediate electronic device to the first cluster header in response to the MCR message 702. Similar to the MCR message, the MCR relay message 704 includes information about traffic load and a number of channels used in the second cluster. The first cluster header receives the MCR relay message 704 and compares the traffic load of the second cluster with that of the first cluster. Based upon the comparison, the first cluster header can allocate the one or more channels to the second cluster header.

Allocating one or more channels can be described mathematically with reference to the following equation.

$$Channel Allocation = \{ \begin{matrix}1 , & if f ( {L}_{self} , {N}_{f\_self} - n ) > f ( {L}_{other} , {N}_{f\_other} + n ) \\ 0 , & if f ( {L}_{self} , {N}_{f\_self} - n ) < = f ( {L}_{other} , {N}_{f\_other} + n )\end{matrix}$$

where,
L_{self} is a traffic load in a first cluster;
Lₒₜₕₑᵣ is a traffic load in a second cluster;
N_{f}_{_{—}}ₒₜₕₑᵣ is a current number of channels allocated in the second cluster;
n is a number of channels to be allocated by the first cluster to the second cluster;
N_{f}_{_{—}}_{self} is a current number of channels allocated in the first cluster; and
ƒ( ) is a function that provides an indication of traffic load status.

One example of ƒ( ) is a function that is related to the number of channels in the cluster and the traffic load in the cluster. As such, one example of ƒ( ) can mathematically be described with reference to the following equation.

$$f ( {L}_{self} , {N}_{f\_self} - 1 ) = \frac{{L}_{self}}{{N}_{f\_self} - 1} = \frac{{\sum }_{i = 1}^{m} {λ}_{i}}{{N}_{f\_self} - 1}$$

where,
∥ᵢ s a data arrival rate in the cluster; and
m is the number of flows in the cluster.

Utilizing such a function, a traffic load status on the first cluster when the first cluster provides an allocation of one or more channels to the second cluster can be calculated, namely ƒ(L_{self},N_{ƒ self}−n). Further, a traffic load status of the second cluster when the first cluster provides an allocation of one or more channels to the second cluster can be calculated, namely ƒ(LₒₜₕₑᵣN_{ƒ}_{_{—}}ₒₜₕₑᵣ+n) If the channel allocation equation equals one, e.g. when the traffic load status ƒ(L_{self}, N_{ƒ}_{_{—}}_{self}−n) on the first cluster is more than the traffic load status ƒ(Lₒₜₕₑᵣ,N_{ƒ}_{_{—}}ₒₜₕₑᵣ+n) on the second cluster, then one or more channels is allocated to the second cluster header. If the channel allocation equation equals zero, e.g. when the traffic load status ƒ(L_{self},N_{ƒ}_{_{—}}_{self}−n) on the first cluster is less than or equal to the traffic load status ƒ(Lₒₜₕₑᵣ,N_{ƒ other}+n) on the second cluster, then one or more channels is not allocated to the second cluster header.

If the channel allocation equation equals one, then the first cluster header allocates one or more channels to the second cluster. Further, the first cluster header 114 sends a MCA message 706 to the second cluster header 116. As shown in FIG. 11, the MCA message 706 can include the selected channels for the second cluster 104. As such the MCA message 706 includes a number of channels field 1110 and the channel ID list 1112.

If the channel allocation equation equals zero, then the first cluster header does not allocate any channels to the second cluster. In such an embodiment, the number of channels field 1110 in the MCA message 706 will be set to zero (or alternatively blank) to communicate that no channels have been allocated by the first cluster header for the second cluster. Furthermore, the channel ID list 1112 is not used in the MCA message 706 since no channels have been allocated. As such, setting to zero (or alternatively blank) in the number of channels field 1110 without the channel ID list 1112 in the MCA message 706 indicates that access to the one or more channels is not granted to the second cluster header by the first cluster header.

Whether channels are allocated or not, the first cluster header sends the MCA message 706 to the intermediate electronic device. To forward the MCA message 706, the intermediate electronic device converts the received MCA message into a MCA relay message 708 by replacing the destination cluster header ID (e.g. 1108) with the second cluster header's ID. Then, the intermediate electronic device sends a MCA relay message 708 to the second cluster header upon receiving the MCA message 706 from the first cluster header. The MCA relay message 708 may include a destination cluster header ID 1108, a number of channels 1110 and the channel ID list 1112 assigned to the second cluster header. Further, the first cluster header can also make a request for access to the channels from the second cluster header of the second cluster when there is a shortage of channels in the first cluster.

FIG. 8 illustrates a message flow diagram for selecting an intermediate electronic device. In one embodiment, the step of selecting an intermediate electronic device requires that one electronic device be designated as representative for a given channel. For example, in FIG. 8, the second cluster header may have chosen electronic device 802 from among a number of electronic devices 802, 804, 806 associated with one channel as representative of a given channel. In one embodiment, choosing a representative electronic device means that the cluster header determines that the electronic device has channel characteristics and/or conditions that are acceptable for communications. For example, electronic device 802 may have high signal quality for communication with a second cluster header, e.g. 116. In any case, determining good channel characteristics and/or conditions may be based upon at least one of signal strength, channel conditions, and quality of service.

Once an electronic device per channel has been determined, then the second cluster header selects an intermediate electronic device. Selecting the intermediate electronic device may be based upon predefined criteria such as signal, strength, channel conditions, and quality of services for the intermediate electronic device. The intermediate electronic device is chosen from among candidate electronic devices, e.g. the electronic devices 802, 804, 806. For the purpose of this description, the electronic devices 802, 804, 806 are assumed to be in an overlap region of a first cluster and a second cluster. The electronic devices 802, 804, 806 are within the communication range of the first cluster header and the second cluster header. The second cluster header selects an intermediate electronic device, e.g. the electronic device 806, to communicate with the first cluster header.

To initiate the selecting, the second cluster header sends an Intermediate Electronic Device Grant (IEDG) message 810 to the electronic device 802, an IEDG message 812 to the electronic device 804, and an IEDG message 814 to the electronic device 806. The IEDG messages 810, 812, 814 are sent to select an intermediate electronic device from among the electronic devices 802, 804, 806. The electronic devices 802, 804, 806 send IEDG response messages 816 818, 820, respectively, to the second cluster header. The IEDG response messages 816, 818, 820 include a cluster header ID and a channel ID list identifying channels of the cluster to which each of the electronic devices 802, 804, 806 belong. The second cluster header selects an electronic device, e.g. the electronic device 806, as the selected intermediate electronic device based upon channel characteristics and/or conditions of the intermediate electronic device.

To communicate that the electronic device has been selected, the second cluster header sends an IEDG confirmation message 822 to the electronic device 806 selected as the intermediate electronic device. The selected electronic device 806 sends a first acknowledgement message 824 in response to the IEDG confirmation message 822 to the second cluster header to confirm acceptance of the electronic device 806 as the intermediate electronic device. Thus, the electronic device 806 is designated as the intermediate electronic device for communication between the first cluster header and the second cluster header. If the electronic device 806 does not send a first acknowledgement message 824 in response to the IEDG confirmation message 822 to the second cluster header, the second cluster header selects another electronic device from the available electronic devices, e.g. 802, 804, as the intermediate electronic device. As mentioned before, such a selection may be based upon channel characteristics and/or conditions. The second cluster header sends again another IEDG confirmation message (e.g. 822) to the next selected electronic device.

In the above description, specific messages are mentioned. For example, an IEDG message, an IEDG response message, an IEDG confirmation message, and a first acknowledgement message are described. In one example, these messages may be proprietary messages that signal information. As such, all the IEDG related messages including IEDG message 810, IEDG Response Message 816, IEDG Confirmation Message 822, and First Acknowledgement Message 824 commonly include a preamble (e.g. 1002), a physical layer header 1004, a Medium Access Control (MAC) header 1006 like MCR or MCA message. Similar to the MCR and MCA messages, the IEDG related messages have unique message IDs which identify the type of message. Unlike IEDG message 810, IEDG Confirmation Message 822, and First Acknowledgement Message 824, and IEDG Response Message 816 identify a cluster and channels associated with the cluster.

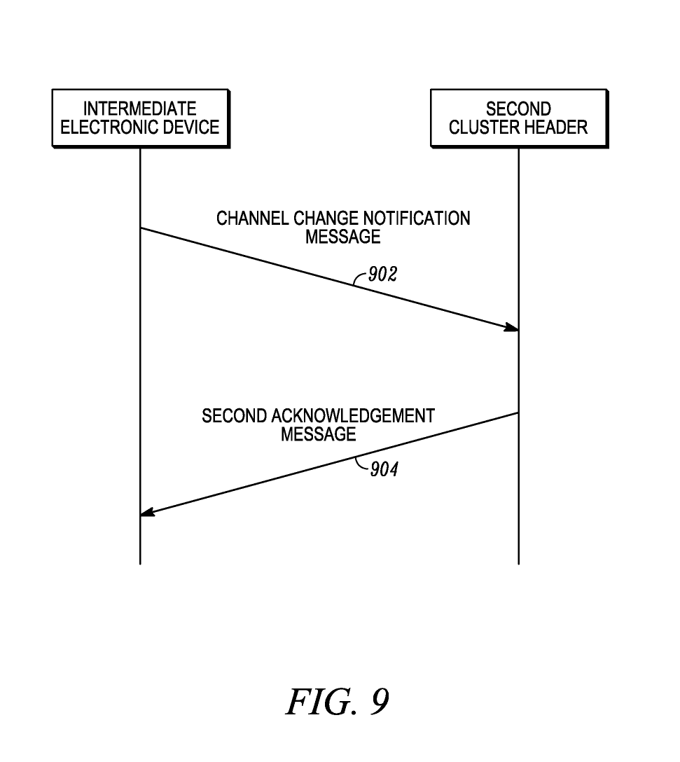

FIG. 9 illustrates a message flow diagram for indicating a change of a channel for an intermediate electronic device (e.g. 112) and a cluster header (e.g. second cluster header 116). The intermediate electronic device is used by the second cluster header to communicate with the first cluster header (e.g. 114). If there is a change in a channel allocated to the intermediate electronic device, the intermediate electronic device informs the second cluster header by sending a channel-change-notification message 902. The channel change notification message 902 includes information about a new channel allocated to the intermediate electronic device. The second cluster header sends a second acknowledgement 904 to the intermediate electronic device to confirm that the second cluster header has updated the information of the new channel allocated to the intermediate electronic device.

The method and system for allocating channels in a wireless network offers various advantages. The invention can be used to allocate channels in one or more clusters. This helps in maximizing the throughput of the network, since channels that are not being used in a particular cluster can be allocated to another cluster. Further, allocating channels among the one or more clusters helps to prevent channel starvation at a particular cluster, since channels can be allocated from a neighboring cluster. Further, the invention dynamically allocates channels among the one or more clusters based upon the traffic load and the number of channels in the one or more clusters.

It will be appreciated that the method and system for allocating channels in a wireless network described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. Therefore, these functions may be interpreted as steps of a method, to enable users to view a broadcasted media stream differently. Alternatively, some or all the functions could be implemented by a state machine that has no stored program instructions, or in one or more application-specific integrated circuits (ASICs) in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for allocating channels in a wireless network, the wireless network comprising a plurality of electronic devices organized into clusters and communicating with each other through a plurality of channels, the method performed by an electronic device comprising:
scanning the plurality of channels for a frame generated in a first cluster;
determining that the frame is a beacon frame transmitted by a first cluster header in the first cluster;
sending a channel request to the first cluster header;
receiving a channel request response from the first cluster header; and
designating the electronic device as a second cluster header for a second cluster.

2. The method as recited in claim 1, further comprising initiating the channel request to the first cluster header when unused channels exist in the first cluster, wherein the unused channels are assigned to the second cluster

3. The method as recited in claim 1, further comprising:
initiating the channel request to the first cluster when there are no unused channels in the first cluster;
allocating a channel by the first cluster header to the second cluster based upon at least one of a) a traffic load in the first cluster, b) a traffic load in the second cluster, c) a number of channels allocated to the first cluster, and d), a number of channels allocated to the second cluster.

4. The method as recited in claim 3, wherein the step of allocating can be described mathematically by a channel allocation equation.

5. The method as recited in claim 3, wherein the channel request is sent to the first cluster header via an intermediate electronic device.

6. The method as recited in claim 3, further comprising notifying the second cluster header of the allocated channel available for the second cluster.

7. The method as recited in claim 1, further comprising:
determining that the frame is a non-beacon frame sent by a second electronic device in the first cluster;
determining the second electronic device to be an intermediate electronic device
selecting an intermediate electronic device as the intermediate electronic device based upon a first predefined criteria,
wherein the selected intermediate electronic device enables the electronic device to communicate with the first cluster header.

8. The method as recited in claim 7, wherein selecting the intermediate electronic device comprises:
sending one or more Intermediate Electronic Device Grant (IEDG) messages to each of the plurality of candidate electronic devices;
receiving one or more IEDG response messages in response to the one or more IEDG messages;
determining the intermediate electronic device based upon comparing a second predefined criteria associated with the received IEDG response messages with the first predefined criteria;
sending an IEDG confirmation message to the determined intermediate electronic device in response to the received one or more IEDG response messages; and
receiving a first acknowledgement message from the intermediate electronic device in response to the IEDG confirmation message.

9. The method as recited in claim 8, wherein the second predefined criteria are selected from a group comprising signal strength, channel conditions, and quality of service.

10. The method as recited in claim 7, further comprising:
receiving a channel change notification message when a channel allocated to the intermediate electronic device is changed, the channel change notification message being sent by the intermediate electronic device to the second cluster header; and
sending a second acknowledgement message from the second cluster header in response to the channel change notification message.

11. The method as recited in claim 1, further comprising:
at a second electronic device:
scanning the plurality of channels for a frame generated in the first cluster;
determining that the frame is undetected;
selecting at least one channel from the plurality of channels; and
creating a third cluster using the at least one channel, wherein the second electronic device is designated as the third-cluster header.

12. The method as recited in claim 1, further comprising:
negotiating for channels by sending a more channel request (MCR) message from the second cluster header to the first cluster header;
comparing by the first cluster header a traffic load of the first cluster with that of the second cluster;
selecting by the first cluster header a channel for the second cluster; and
receiving a more channel assign (MCA) message comprising the selected channel for the second cluster.

13. A method for allocating channels in a wireless network, the wireless network comprising a plurality of electronic devices organized into clusters and communicating with each other through a plurality of channels, the method performed by an electronic device comprising:
scanning the plurality of channels for a frame generated in a first cluster;
if the frame is not a beacon frame, selecting an intermediate electronic device, wherein the intermediate electronic device allows the electronic device to communicate with a first cluster header of the first cluster;
determining that there are no unused channels in the first cluster;
sending a channel request to the first cluster header;
designating the electronic device as a second cluster header for a second cluster;
negotiating for one or more channels from the first cluster header for allocation to the second cluster; and
receiving a channel request response from the first cluster header.

14. The method as recited in claim 13, wherein the channel request is a more channel request (MCR) message.

15. The method as recited in claim 13, wherein the channel request response identifies the one or more channels allocated to the second cluster.

16. The method as recited in claim 13, wherein the step of negotiating further comprises determining that a traffic load status on the second cluster is more than a traffic load status on the first cluster to allocate the one or more channels from the first cluster to the second cluster.

17. The method as recited in claim 13, wherein the channel request response indicates that no channels have been allocated to the second cluster.

18. The method as recited in claim 13, further comprising the step of indicating a change in the allocation by sending a channel change notification message.

19. An electronic device comprising:
a receiver capable of receiving a beacon frame from a first cluster header in a wireless network, wherein the wireless network is organized into one or more clusters; and;
a transmitter capable of transmitting a channel request in response to receiving the beacon frame; and
a processor capable of creating a second cluster in response to the channel request, wherein the electronic device is designated as a second cluster header.

20. The electronic device as recited in claim 13, wherein the receiver and the transmitter are integrated together.
